(19) United States
(12) Patent Application Publication
(10) Pub. No.: US 2008/0244553 A1
(43) Pub. Date: Oct. 2, 2008

(54) System and Method for Securely Updating Firmware Devices by Using a Hypervisor

(76) Inventors: Daryl Carvis Cromer, Cary, NC (US); Howard Jeffrey Locker, Cary, NC (US); Randall Scott Springfield, Chapel Hill, NC (US); Rod D. Waltermann, Rougemont, NC (US)

Correspondence Address: LENOVO - JVL;C/O VANLEEUWEN & VANLEEUWEN, P.O. BOX 90609, AUSTIN, TX, 78709-0609, US

(21) Appl. No.: 11/692,283

(22) Filed: Mar. 28, 2007

(51) Int. Cl. G06F 9/44

(52) U.S. Cl. 717/168

(57) ABSTRACT

A system, method, and program product is provided that receives and processes a firmware update at a computer system. The computer system is executing a hypervisor and one or more guest operating systems, and the firmware update corresponds to a hardware device accessible by the computer system. The hardware device is a type that is programmed using an updateable firmware. The hypervisor operating in the computer system processes the received firmware update by first inhibiting use of the device by each of the guest operating systems. After the guest operating systems have been inhibited from using the device, the firmware in the device is upgraded by the hypervisor using the received firmware update. After the firmware has been upgraded, each of the guest operating systems is allowed use of the device.

### BACKGROUND OF THE INVENTION

1. Technical Field

The present invention relates to a system and method that securely updates firmware devices. More particularly, the present invention relates to a system and method that uses hypervisor to provide a secure environment to update firmware devices.

2. Description of the Related Art

Firmware is a software program or set of instructions programmed on a hardware device. Firmware provides the instructions that control how the device communicates with other computer hardware, including the main system. Firmware is typically stored in the flash ROM (Read-Only Memory) of a hardware device. While ROM is generally a “read-only memory,” flash ROM is a type of flash memory that can be erased and rewritten.

Firmware can be thought of as “semi-permanent” since it remains the same unless it is updated by a firmware updater. Firmware of certain devices, such as hard drives and video cards, may need to be updated from time to time in order for them to work properly (e.g., due to a new operating system being installed on the computer system). Firmware is also updated in order to improve device functionality and efficiency. For example, CD and DVD drive manufacturers often make firmware updates available that allow the drives to read faster media.

Manufacturers have found that loading the firmware from the host computer system is both cheaper and more flexible. As a result, much current hardware is unable to function in any useful way until the host computer has fed it the requisite firmware. This firmware load is handled by the device driver.

In some respects firmware is as much a software component of a working system as the operating system. However, unlike most modern operating systems, traditional computer systems are challenged by a lack of a well evolved mechanism for updating the firmware in order to fix bugs and address functionality issues that are detected after the unit is shipped.

Another challenge facing traditional firmware updates is that mechanisms for detecting firmware versions and updating them are not standardized. As a result, these devices tend to have a significantly higher percentage of firmware-driven functionality issues, as compared to other parts of a modern computer system.

Challenges regarding updating firmware are exacerbated by increasing complexities in modern computer systems. Modern computer systems may have more than one operating system running on the system at a given time. In addition, an increasing number of programs are maleficent, such as software viruses. These rogue applications have the potential in most traditional systems of updating, or even deleting, a device's firmware. These challenges are even more evident in large organizations that desire stable systems with standard software, including device drivers, that can be tracked and managed by the organizations' help desk.

### SUMMARY

It has been discovered that the aforementioned challenges are resolved using a system, method and computer program product that receives and processes a firmware update at a computer system. The computer system is executing a hypervisor and one or more guest operating systems, and the firmware update corresponds to a hardware device accessible by the computer system. The hardware device is a type that is programmed using an updateable firmware. The hypervisor operating in the computer system processes the received firmware update by first inhibiting use of the device by each of the guest operating systems. After the guest operating systems have been inhibited from using the device, the firmware in the device is upgraded by the hypervisor using the received firmware update. After the firmware has been upgraded, each of the guest operating systems is allowed use of the device.

In one embodiment, prior to upgrading the firmware, the firmware update is validated. In this embodiment, the upgrading is only performed in response to a successful validation of the firmware update.

In a further validation embodiment, the validation includes receiving a password that is used to control firmware updates from the user of the computer system. The password supplied by the user is compared to an expected password. In this embodiment, the upgrading is only performed when the received password matches the expected password.

In another validation embodiment, a digital signature included with the received firmware update is analyzed. In this embodiment, the upgrading is only performed after verifying that the received firmware update has been digitally signed by an authorized user. For example, using asymmetric keys, an authorized user digitally signs (encrypts) the firmware update using the authorized user's private key. The hypervisor verifies the digital signature by decrypting the signed firmware update using the authorized user's public key.

In yet another validation embodiment, the hypervisor executes a hash algorithm against the received firmware update, resulting in a hash value. The hash value is compared with an expected hash value. In this embodiment, the firmware update is rejected in response to the hash value not matching the expected hash value, and the firmware update is accepted in response to the hash value matching the expected hash value. For example, a system administrator can supply expected hash values for firmware updates. The computer system can then download a firmware update from a public source, such as a web site accessible from the Internet. The hypervisor verifies that the firmware update is valid by running the hash algorithm against the downloaded firmware update. If the hash value does not match the expected hash value, perhaps indicating a spoofed firmware update containing malevolent code, the hypervisor rejects the firmware update.

In one embodiment, in order to inhibit use of the device that is being updated, the hypervisor unmounts the device from each of the guest operating systems. The hypervisor then suspends each of the guest operating systems. After the firmware of the device has been upgraded, the hypervisor allows use of the device by resuming each of the guest operating systems, and mounting the device to each of the guest operating systems after the guest operating systems have been resumed.

In one embodiment, in order to inhibit use of the device that is being updated, the hypervisor buffers requests received from the guest operating systems in a buffer. After the firmware of the device has been upgraded, the hypervisor allows use of the device by sending the buffered requests to the device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a high-level diagram showing selected computer components used in updating device firmware using a hypervisor;

FIG. 2 is a high-level flowchart showing the steps taken to update device firmware using a hypervisor;

FIG. 3 is a flowchart showing the steps taken to validate firmware update software;

FIG. 4 is a flowchart showing steps taken by the hypervisor to prepare the computer system for a firmware update;

FIG. 5 is a flowchart showing further steps taken by the hypervisor to initialize the firmware update and make it available to the guest operating system(s); and

FIG. 6 is a block diagram of a data processing system in which the methods described herein can be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

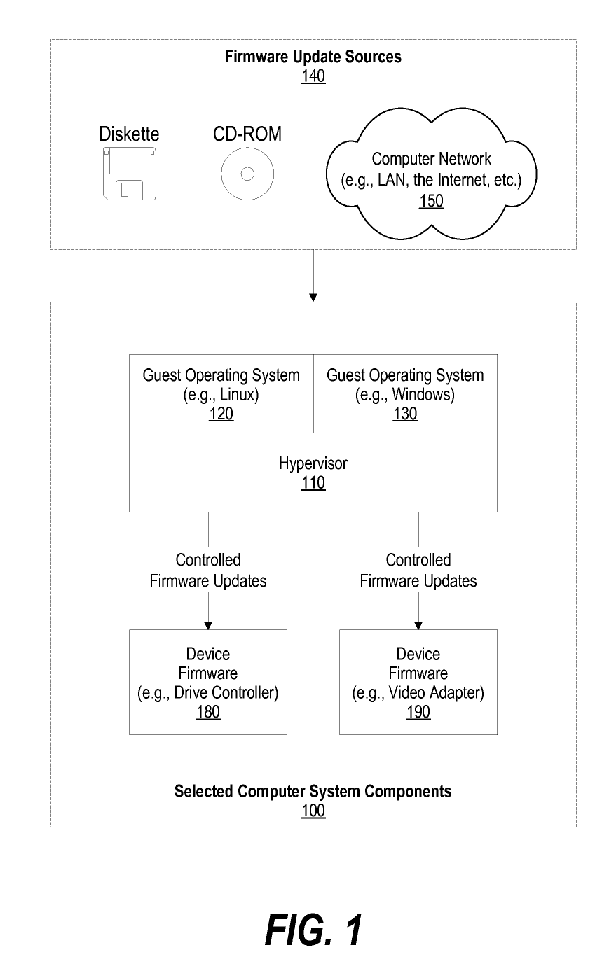

FIG. 1 is a high-level diagram showing selected computer components used in updating device firmware using a hypervisor. Selected computer system components 100 include hypervisor 110 upon which one or more guest operating systems operate. In the embodiment shown, two guest operating systems are operating under the control of hypervisor 110. Examples of guest operating systems include the Linux™ operating system 120 and a Microsoft Windows™ operating system 130 (such as Windows XP™, Windows Vista™, etc.).

Firmware update sources 140 include any available source of the firmware update that is being used to upgrade the firmware of a device that is accessible to the computer system. Examples of firmware update sources include diskettes, CD-ROMs, and files accessible from computer networks 150, such as the Internet or a local area network (LAN). Network accessible files include firmware updates accessible from a Website on the Internet or files accessible from a shared network drive accessible from a LAN, such as a LAN provided by an organization for its employees. Firmware updates are often available from a manufacturer's Website to improve or provide functionality of the manufacturer's devices. The processing shown herein can be used to verify that the firmware updates found on computer networks 150 are legitimate (i.e., approved) updates and can be used to prevent installation of spoofed firmware updates that may contain malevolent code designed to damage or disrupt operation of the computer system.

In the example shown, selected computer system 100 includes two devices (180 and 190) that are accessible from the computer system that each have upgradeable firmware that controls their operation. Examples of such devices include drive controllers and video adapters. Manufactures of these devices often supply firmware updates that are installed on the device's firmware. The firmware updates includes the software used to control the operation of the device. In some cases, devices are shipped without software being installed on the device's firmware. In these cases, the firmware update includes the initial firmware (software) loaded in the device's firmware to provide functionality of the device. While some firmware updates are specific to a particular device, other firmware updates are “generic” and can be applied to a wide variety of devices. For example a generic video adapter firmware can be applied to a wide variety of video adapters in order to provide basic functionality of the video adapter. Generic, or basic, firmware updates are often included in the operating system and used to initialize devices when first configuring the operating system.

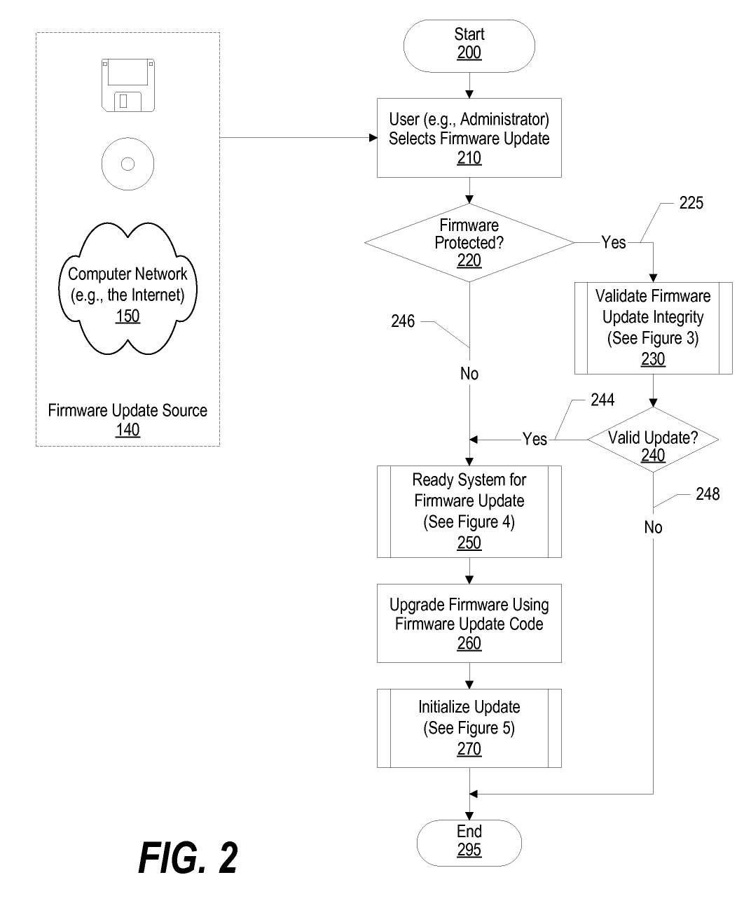

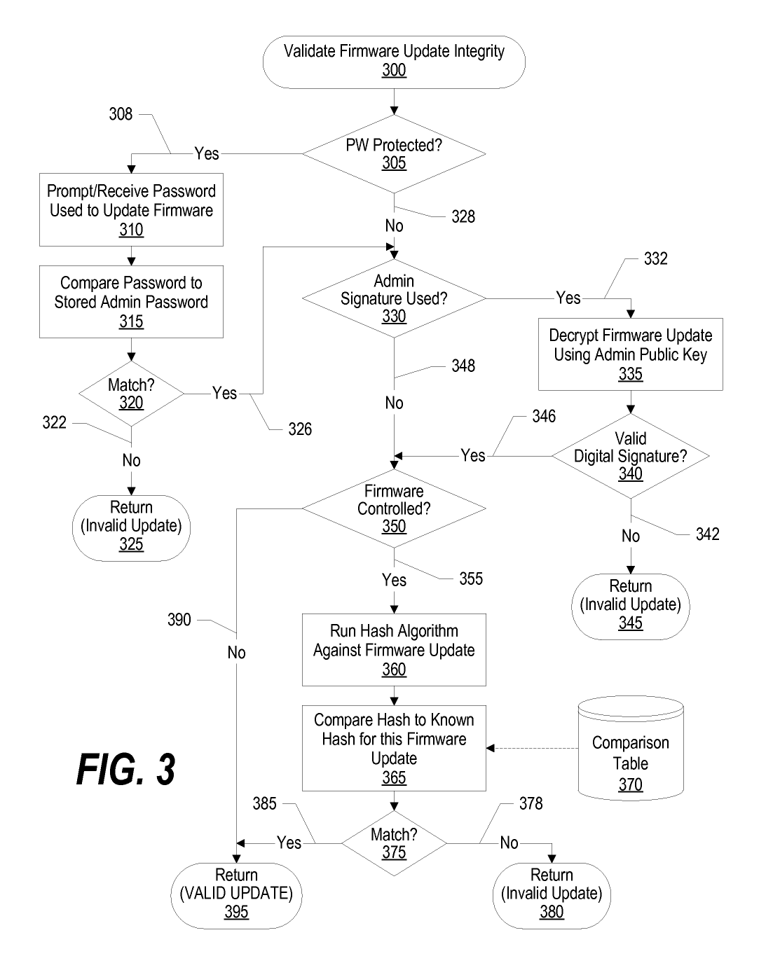

FIG. 2 is a high-level flowchart showing the steps taken to update device firmware using a hypervisor. Processing commences at 200 whereupon, at step 210, the user of the computer system selects a firmware update to install in a device that is accessible to the user's computer system. A determination is made as to whether the firmware on the computer system is protected (decision 220). If firmware on the computer system is protected, then decision 220 branches to “yes” branch 225 whereupon, at predefined process 230, the integrity of the firmware update is validated using one or more of a variety of different validation techniques (see FIG. 3 and corresponding text for processing details). After validation has been performed, a determination is made as to whether the firmware update is valid (decision 240). If the firmware update is not valid, then decision 240 branches to “no” branch 248 whereupon processing ends at 295 without updating the device's firmware. On the other hand, if the update is valid, then decision 240 branches to “yes” branch 244 to continue the firmware update process. Returning to decision 220, if the firmware is not protected, then decision 220 branches to “no” branch 246 bypassing validation steps 230 and 240.

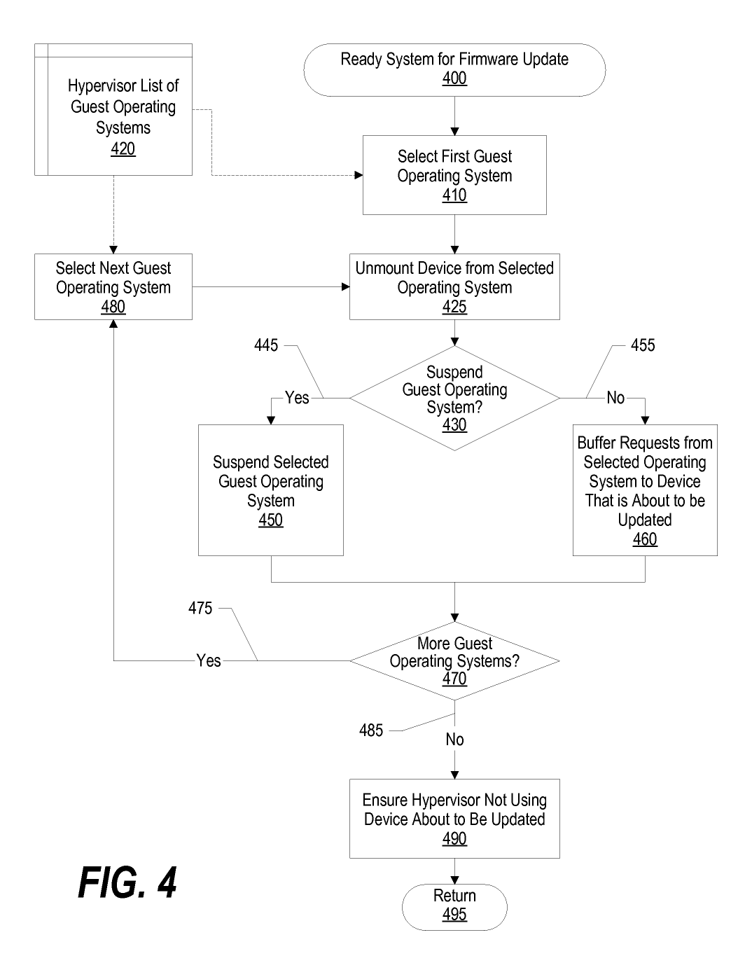

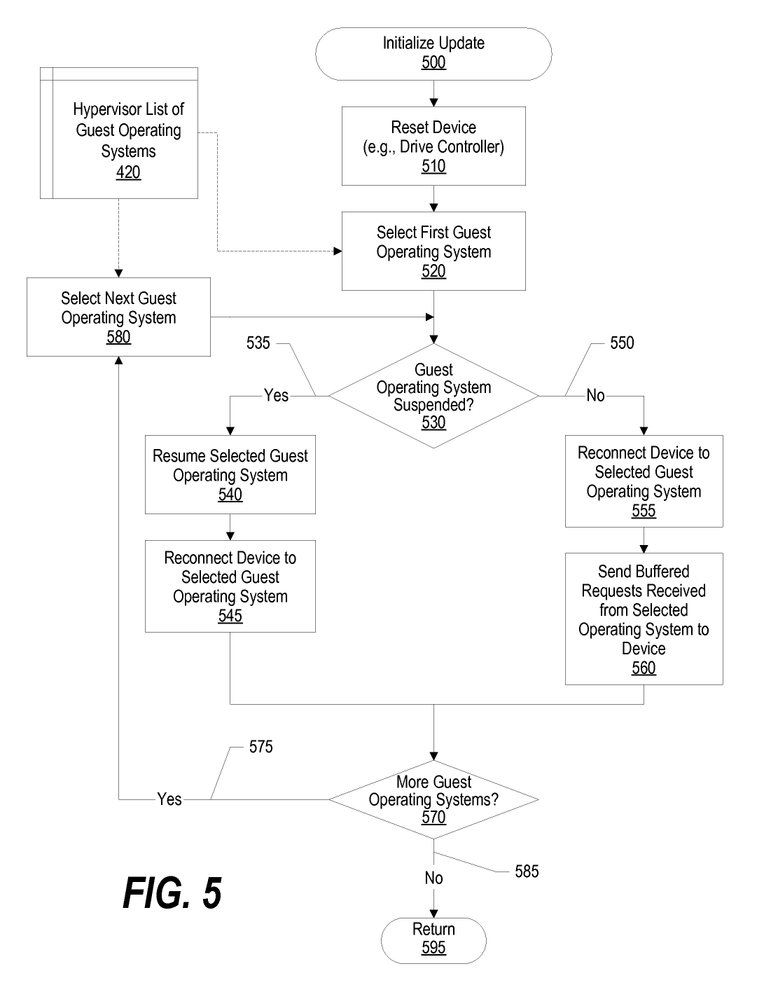

Firmware update processing continues by readying the computer system for the firmware update (predefined process 250, see FIG. 4 and corresponding text for processing details). Readying the computer system for the firmware update includes inhibiting the guest operating systems from using the device that is being updated until the update is complete. After the computer system is ready to accept the firmware update, at step 260, the device's firmware is upgraded using the firmware update code. After the device's firmware has been upgraded, at predefined process 270, the update is initialized on the computer system (see FIG. 5 and corresponding text for processing details). Initialization of the update includes allowing the guest operating systems to use the device. The hypervisor's update of the device's firmware then ends at 295.

FIG. 3 is a flowchart showing the steps taken to validate firmware update software integrity. This routine is called from predefined process 230 shown in FIG. 2. In FIG. 3, validation of firmware update commences at 300 whereupon a determination is made as to whether a password is used to control updating the firmware of a device accessible from the computer system (decision 305). For example, in an organization a system administrator may be responsible for updating device firmware. In such an organization, a user would need to supply a password in order to update a device's firmware. If the password that is needed to update a device's firmware is not supplied, the hypervisor does not allow the user to update the firmware. If a password is being used to control updates to device firmware, then decision 305 branches to “yes” branch 308 whereupon, at step 310, the user is prompted for a password that is used (authorized) to update device firmware. At step 315, the hypervisor compares the password that was supplied by the user to a stored authorized password. A determination is made as to whether the password supplied by the user matches a password that is used to control updates to the firmware (decision 320). If the password supplied by the user does not match an authorized password used to control updates to the firmware, then decision 320 branches to “no” branch 322 whereupon processing returns to the calling routine at 325 with a return code that indicates that the update is invalid (see decision 240 in FIG. 2 for processing performed by the calling routine upon receipt of the return code). On the other hand, if the password supplied by the user matches a password used to control updates to device firmware, then decision 320 branches to “yes” branch 326 to continue validating the integrity of the firmware update. Returning to decision 305, if a password is not needed to update device firmware, then decision 305 branches to “no” branch 328 bypassing steps 310 to 325.

A determination is made as to whether a digital signature is used to validate the firmware update (decision 330). If digital signatures are being used, then approved firmware updates are digitally signed by an authorized user, such as an administrator. One way of digitally signing the firmware updates is by using asymmetric keys where the authorized user digitally signs the firmware update using a private key to encrypt the firmware update. The digitally signed (encrypted) firmware update can be decrypted using the authorized user's public key. If digital signatures are being used, then decision 330 branches to “yes” branch 332 whereupon, at step 335 the hypervisor attempts to decrypt the firmware update using a public key that corresponds to the authorized user (e.g., a system administrator). A determination is made as to whether the digital signature is valid (decision 340) based upon whether the public key was able to decrypt the firmware update that was encrypted using the authorized user's private key. If the digital signature is not verified, then decision 340 branches to “no” branch 342 whereupon processing returns to the calling routine at 345 with a return code that indicates that the update is invalid (see decision 240 in FIG. 2 for processing performed by the calling routine upon receipt of the return code). On the other hand, if the digital signature is verified, then decision 340 branches to “yes” branch 346 to continue validating the integrity of the firmware update. Returning to decision 330, if a digital signature is not being used to validate the firmware update, then decision 330 branches to “no” branch 348 bypassing steps 335 to 345.

A determination is made as to whether the firmware update is controlled using a hash table (decision 350). Using a hash table allows system administrators to provide a list of expected hash values that correspond to various firmware updates. In this manner, the actual firmware update can be retrieved from a public Website accessible from the Internet where the security of the Website is unknown. If the firmware updates are being controlled using a hash table, then decision 350 branches to “yes” branch 355 whereupon, at step 360, the hypervisor executes a hash algorithm against the firmware update that was downloaded by the user. The execution of the hash algorithm results in a hash value. At step 365, the hypervisor compares the hash value that resulted from the hash algorithm with an expected hash value by retrieving the expected hash value from comparison table 370 that includes a list of expected hash values that correspond to various approved firmware updates. Comparison table 370 includes identifying information about the firmware updates, such as the filename of the firmware update along with the expected hash value when the hash algorithm is run against the given firmware update file. If the firmware update file has been spoofed, altered, or otherwise compromised, the hash value will not match the expected hash value. A determination is made as to whether the hash value resulting from the hash algorithm matches the expected hash value (decision 375). If the hash value resulting from the hash algorithm does not match the expected hash value, then decision 375 branches to “no” branch 378 whereupon processing returns to the calling routine at 380 with a return code that indicates that the update is invalid. On the other hand, if the hash value resulting from the hash algorithm matches the expected hash value, then decision 375 branches to “yes” branch 385 whereupon a return code is returned to the calling routine indicating that the firmware update has been validated. Returning to decision 350, if the firmware update is not controlled using a hash table, then decision 350 branches to “no” branch 390 whereupon the return code is returned to the calling routine indicating that the firmware update has been validated. See decision 240 in FIG. 2 for processing performed by the calling routine upon receipt of the return code.

FIG. 4 is a flowchart showing steps taken by the hypervisor to prepare the computer system for a firmware update. Processing commences at 400 whereupon, at step 410, the first guest operating system that is running under the hypervisor is retrieved from hypervisor's list 420 of guest operating systems that are operating under the hypervisor. At step 425, the hypervisor unmounts the device from the selected operating system. A determination is made as to whether the guest operating system is being suspended or if requests directed to the device by the guest operating system are being buffered by the hypervisor (decision 430). In one embodiment, each of the guest operating systems is handled the same way (either suspended or requests are buffered), while in another embodiment, each operating system can be handled differently based upon the characteristics of the particular guest operating system and the device that is being updated (i.e., some guest operating systems handle being suspended better than others while some devices are used quite frequently making buffering of the various requests to the device more difficult). The hypervisor decides whether to suspend the guest operating system or buffer the guest operating system's requests to the device. If the guest operating system is being suspended, then decision 430 branches to “yes” branch 445 whereupon, at step 450, the selected guest operating system is suspended. On the other hand, if requests to the device from the selected guest operating system are being buffered, then decision 430 branches to “no” branch 455 whereupon, at step 460, requests from the selected guest operating system to the device that is being updated are buffered by the hypervisor.

A determination is made as to whether there are more guest operating systems that are running under the hypervisor (decision 470). If there are more guest operating systems running under the hypervisor, then decision 470 branches to “yes” branch 475 whereupon, at step 480, the next guest operating system is selected from list 420 and processing loops back to inhibit the newly selected guest operating system from using the device (by either suspending the guest operating system or buffering requests to the device by the guest operating system). This looping continues until all guest operating systems running under the hypervisor have been processed, at which point decision 470 branches to “no” branch 485.

At step 490, the hypervisor ensures that it (the hypervisor) is not using the device that is about to receive a firmware update. At 495, processing returns to the calling routine (see FIG. 2) to upgrade the device's firmware using the firmware update that is being applied.

FIG. 5 is a flowchart showing further steps taken by the hypervisor to initialize the firmware update and make it available to the guest operating system(s). Processing commences at 500 whereupon, at step 510, the device that has been updated with new firmware code is reset. At step 520, the hypervisor selects the first guest operating system from the hypervisor's list 420 of guest operating systems that are running under the hypervisor.

A determination is made as to whether the selected guest operating system has been suspended (decision 530). If the selected guest operating system has been suspended, then decision 530 branches to “yes” branch 535 whereupon, at step 540, the selected guest operating system is resumed and, at step 545, the device is reconnected (e.g., “mounted”) to the selected guest operating system. On the other hand, if the selected guest operating system was not suspended, then decision 530 branches to “no” branch 550 whereupon, at step 555, the device is reconnected to the selected guest operating system and, at step 560, requests that were sent to the device by the selected guest operating system and buffered by the hypervisor are processed (i.e., the buffered requests are sent to the device after the device is reset).

A determination is made as to whether there are more guest operating systems running under the hypervisor (decision 570). If there are more guest operating systems running under the hypervisor, then decision 570 branches to “yes” branch 575 whereupon, at step 580, the next guest operating system is selected from list 420 and processing loops back to allow use of the device by the newly selected guest operating system (by either resuming the guest operating system or processing buffered requests). This looping continues until all guest operating systems running under the hypervisor have been processed, at which point decision 570 branches to “no” branch 485 whereupon processing returns to the calling routine at 495 (see FIG. 2).

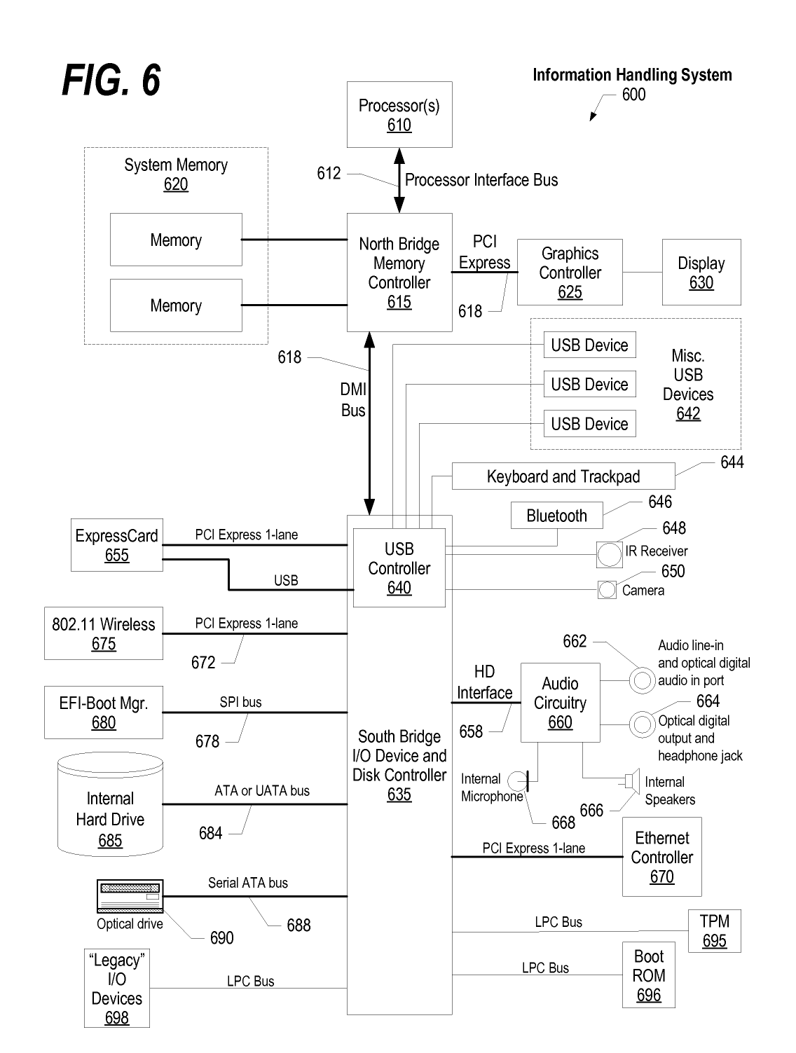

FIG. 6 illustrates information handling system 600 which is a simplified example of a computer system capable of performing the computing operations described herein. Information handling system 600 includes one or more processors 610 which is coupled to processor interface bus 612. Processor interface bus 612 connects processors 610 to Northbridge 615, which is also known as the Memory Controller Hub (MCH). Northbridge 615 is connected to system memory 620 and provides a means for processor(s) 610 to access the system memory. Graphics controller 625 is also connected to Northbridge 615. In one embodiment, PCI Express bus 618 is used to connect Northbridge 615 to graphics controller 625. Graphics controller 625 is connected to display device 630, such as a computer monitor.

Northbridge 615 and Southbridge 635 are connected to each other using bus 618. In one embodiment, the bus is a Direct Media Interface (DMI) bus that transfers data at high speeds in each direction between Northbridge 615 and Southbridge 635. In another embodiment, a Peripheral Component Interconnect (PCI) bus is used to connect the Northbridge and the Southbridge. Southbridge 635, also known as the I/O Controller Hub (ICH) is a chip that generally implements capabilities that operate at slower speeds than the capabilities provided by the Northbridge. Southbridge 635 typically provides various busses used to connect various components. These busses can include PCI and PCI Express busses, an ISA bus, a System Management Bus (SMBus or SMB), a Low Pin Count (LPC) bus. The LPC bus is often used to connect low-bandwidth devices, such as the boot ROM and “legacy” I/O devices (using a “super I/O” chip). The “legacy” I/O devices (698) can include serial and parallel ports, keyboard, mouse, floppy disk controller. The LPC bus is also used to connect Southbridge 635 to Trusted Platform Module (TPC) 695. Other components often included in Southbridge 635 include a Direct Memory Access (DMA) controller, a Programmable Interrupt Controller (PIC), a storage device controller, which connects Southbridge 635 to nonvolatile storage device 685, such as a hard disk drive, using bus 684.

ExpressCard 655 is a slot used to connect hot-pluggable devices to the information handling system. ExpressCard 655 supports both PCI Express and USB connectivity as it is connected to Southbridge 635 using both the Universal Serial Bus (USB) the PCI Express bus. Southbridge 635 includes USB Controller 640 that provides USB connectivity to devices that connect to the USB. These devices include webcam (cameral) 650, infrared (IR) receiver 648, Bluetooth device 646 which provides for wireless personal area networks (PANs), keyboard and trackpad 644, and other miscellaneous USB connected devices 642, such as a mouse, portable storage devices, modems, network cards, ISDN connectors, fax, printers, USB hubs, and many other types of USB connected devices.

Wireless Local Area Network (LAN) device 675 is connected to Southbridge 635 via the PCI or PCI Express bus 672. LAN device 675 typically implements one of the IEEE 802.11 standards of over-the-air modulation techniques that all use the same protocol to wireless communicate between information handling system 600 and another computer system or device.

Optical storage device 690 is connected to Southbridge 635 using Serial ATA (SATA) bus 688. Serial ATA adapters and devices communicate over a high-speed serial link. The Serial ATA bus is also used to connect Southbridge 635 to other forms of storage devices, such as hard disk drives.

Audio circuitry 660, such as a sound card, is connected to Southbridge 635 via bus 658. Audio circuitry 660 is used to provide functionality such as audio line-in and optical digital audio in port 662, optical digital output and headphone jack 664, internal speakers 666, and internal microphone 668.

Ethernet controller 670 is connected to Southbridge 635 using a bus, such as the PCI or PCI Express bus. Ethernet controller 670 is used to connect information handling system 600 with a computer network, such as a Local Area Network (LAN), the Internet, and other public and private computer networks.

While FIG. 6 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a firmware update at a computer system, wherein the computer system is executing a hypervisor and one or more guest operating systems, and wherein the firmware update corresponds to a hardware device accessible by the computer system, the hardware device including an updateable firmware;
in response to receiving the firmware update, the hypervisor operates by:
inhibiting use of the device by each of the guest operating systems;
after the inhibiting, upgrading the firmware using the received firmware update; and
after the upgrading, allowing each of the guest operating systems use of the device.

2. The method of claim 1 further comprising:
prior to upgrading the firmware, validating the firmware update, wherein the upgrading is performed in response to a successful validation of the firmware update.

3. The method of claim 2 wherein the validating further comprises:
receiving, from a user, a password that is used to control firmware updates to the computer system; and
comparing the received password to an expected password, wherein the upgrading is performed in response to the received password matching the expected password.

4. The method of claim 2 wherein the validating further comprises:
verifying that the received firmware update has been digitally signed by an authorized user.

5. The method of claim 2 wherein the validating further comprises:
executing a hash algorithm against the received firmware update, the executing resulting in a hash value;
comparing the hash value with an expected hash value;
rejecting the firmware update in response to the hash value not matching the expected hash value; and
accepting the firmware update in response to the hash value matching the expected hash value.

6. The method of claim 1 wherein:
the inhibiting further comprises:
unmounting the device from each of the guest operating systems; and
suspending each of the guest operating systems;
and the allowing further comprises:
resuming each of the guest operating systems; and
mounting the device to each of the guest operating systems.

7. The method of claim 1 wherein:
the inhibiting further comprises:
buffering one or more requests for the device in a buffer, the requests received from one or more of the guest operating systems;
and the allowing further comprises:
sending each of the buffered requests to the device.

8. A information handling system comprising:
one or more processors;
a memory accessible by at least one of the processors;
a nonvolatile storage area accessible by at least one of the processors;
a hardware device accessible by at least one of the processors, wherein the hardware device includes an updateable firmware that controls the device's operation;
a hypervisor and one or more guest operating systems stored in the memory and the nonvolatile storage area and executed by the processors;
a set of instructions executed by the hypervisor, wherein one or more of the processors executes the set of instructions in order to perform actions of:
receiving a firmware update, wherein the firmware update corresponds to the hardware device;
in response to receiving the firmware update:
inhibiting use of the device by each of the guest operating systems;
after the inhibiting, upgrading the firmware using the received firmware update; and
after the upgrading, allowing each of the guest operating systems use of the device.

9. The information handling system of claim 8 wherein the set of instructions perform further actions comprising:
prior to upgrading the firmware, validating the firmware update, wherein the upgrading is performed in response to a successful validation of the firmware update, the validating including:
receiving, from a user, a password that is used to control firmware updates to the computer system; and
comparing the received password to an expected password, wherein the upgrading is performed in response to the received password matching the expected password.

10. The information handling system of claim 8 wherein the set of instructions perform further actions comprising:
prior to upgrading the firmware, validating the firmware update, wherein the upgrading is performed in response to a successful validation of the firmware update, the validating including verifying that the received firmware update has been digitally signed by an authorized user.

11. The information handling system of claim 8 wherein the set of instructions perform further actions comprising:
prior to upgrading the firmware, validating the firmware update, wherein the upgrading is performed in response to a successful validation of the firmware update, the validating including:
executing a hash algorithm against the received firmware update, the executing resulting in a hash value;
comparing the hash value with an expected hash value;
rejecting the firmware update in response to the hash value not matching the expected hash value; and
accepting the firmware update in response to the hash value matching the expected hash value.

12. The information handling system of claim 8 wherein:
the instructions that perform the inhibiting include instructions to perform a first set of actions comprising:
unmounting the device from each of the guest operating systems; and
suspending each of the guest operating systems;
and instructions that perform the allowing include instructions to perform a second set of actions comprising:
resuming each of the guest operating systems; and
mounting the device to each of the guest operating systems.

13. The information handling system of claim 8 wherein:
the instructions that perform the inhibiting include instructions to perform a first set of actions comprising:
buffering one or more requests for the device in a buffer stored in the memory, the requests received from one or more of the guest operating systems;
and instructions that perform the allowing include instructions to perform a second action comprising:
sending each of the buffered requests to the device.

14. A computer program product stored in a computer readable medium, comprising functional descriptive material that, when executed by a data processing system, causes the data processing system to perform actions that include:
receiving a firmware update at a computer system, wherein the computer system is executing a hypervisor and one or more guest operating systems, and wherein the firmware update corresponds to a hardware device accessible by the computer system, the hardware device including an updateable firmware;
in response to receiving the firmware update, the hypervisor operates by:
inhibiting use of the device by each of the guest operating systems;
after the inhibiting, upgrading the firmware using the received firmware update; and
after the upgrading, allowing each of the guest operating systems use of the device.

15. The computer program product of claim 15 wherein the functional descriptive material causes the data processing system to perform further actions comprising:
prior to upgrading the firmware, validating the firmware update, wherein the upgrading is performed in response to a successful validation of the firmware update.

16. The computer program product of claim 15 wherein the functional descriptive material that performs the validating performs further actions comprising:
prior to upgrading the firmware, validating the firmware update, wherein the upgrading is performed in response to a successful validation of the firmware update, the validating further including:
receiving, from a user, a password that is used to control firmware updates to the computer system; and
comparing the received password to an expected password, wherein the upgrading is performed in response to the received password matching the expected password.

17. The computer program product of claim 15 wherein the functional descriptive material that performs the validating performs further actions comprising:
verifying that the received firmware update has been digitally signed by an authorized user.

18. The computer program product of claim 15 wherein the functional descriptive material that performs the validating performs further actions comprising:
executing a hash algorithm against the received firmware update, the executing resulting in a hash value;
comparing the hash value with an expected hash value;
rejecting the firmware update in response to the hash value not matching the expected hash value; and
accepting the firmware update in response to the hash value matching the expected hash value.

19. The computer program product of claim 15 wherein the functional descriptive material causes the data processing system to perform further actions comprising:
the inhibiting further comprises:
unmounting the device from each of the guest operating systems; and
suspending each of the guest operating systems;
and the allowing further comprises:
resuming each of the guest operating systems; and
mounting the device to each of the guest operating systems.

20. The computer program product of claim 15 wherein the functional descriptive material causes the data processing system to perform further actions comprising:
the inhibiting further comprises:
buffering one or more requests for the device in a buffer, the requests received from one or more of the guest operating systems;
and the allowing further comprises:
sending each of the buffered requests to the device.
